(19) United States
(12) Patent Application Publication
(10) Pub. No.: US 2010/0242081 A1
(43) Pub. Date: Sep. 23, 2010

(54) SYSTEM FOR DISTRIBUTING A PLURALITY OF UNIQUE VIDEO/AUDIO STREAMS

(75) Inventors: William R. Dunn, Alpharetta, GA (US); Gerald Fraschilla, Snellville, GA (US); Rick De Laet, Alpharetta, GA (US)

Correspondence Address: STANDLEY LAW GROUP LLP, 6300 Riverside Drive, Dublin, OH, 43017, US

(73) Assignee: MANUFACTURING RESOURCES INTERNATIONAL, INC., Alpharetta, GA (US)

(21) Appl. No.: 12/711,578

(22) Filed: Feb. 24, 2010

Related U.S. Application Data
(60) Provisional application No. 61/154,951, filed on Feb. 24, 2009.

(51) Int. Cl. H04N 7/173

(52) U.S. Cl. 725/126; 725/118

(57) ABSTRACT

A system and method for distributing a plurality of unique streams of video data. Each stream of video data may be encoded with a unique identifier and each receiver may be associated with one of the unique identifiers. The streams of video data may be multiplexed onto a single cable and distributed to the receivers using various networking techniques. A receiver may decode only the video stream for which it has been previously associated with. Once decoded the video stream may be displayed by an electronic display. The streams of video data may be in different resolutions and/or different frame rates from one another. The network may be in two-way communication with the internet so that a receiver's association with a particular stream of video data can be changed remotely.

### CROSS-REFERENCE TO RELATED APPLICATIONS

This application is a non-provisional patent application and claims priority to co-pending U.S. application No. 61/154,951 filed on Feb. 24, 2009 and is herein incorporated by reference in its entirety.

### TECHNICAL FIELD

Exemplary embodiments relate generally to a system for distributing a plurality of unique video/audio streams to a plurality of electronic displays.

### BACKGROUND OF THE ART

Electronic displays are being increasingly utilized for displaying information and/or advertisements. Some installations may contain several electronic displays and users may want to display the same video source on each display, display a different video source on each display, or any combination of these. The displays may also have different resolutions (e.g. 640×480 or 1920×1080) or different refresh rates. The content on these displays may be somewhat static in nature (e.g. menu boards at a fast food restaurant or airport flight arrival/departure boards) or display very dynamic content (e.g. movie advertisements). Some may have audio content associated with the video display, others may be video only.

Previously, a video player (and sometimes audio player) had to be connected to each display. When many displays are being installed in a single location, this can result in a large number of video players. The video players may be located near each display, which makes servicing the video players or altering their content difficult because a user must travel to each video player. If each video player is used in a centralized location, the cost of running cables to each display can be very expensive. However, for many applications it may be preferable to have the content of the displays be delivered from a central location via a network as opposed to having a video player connected directly to each display.

### SUMMARY OF THE INVENTION

As networks and computers become faster it is feasible for multiple video/audio streams to be delivered on a single network cable. Although a compressed video stream can vary in size dramatically based on the resolution and content, it has been discovered that good quality video may be transmitted for resolutions of 1366×768 being displayed with a data rate as low as 40 Mbits/second. Gigabit networks can easily sustain a throughput of 800 Mbits/second or more. It is therefore possible to develop a single video transmitter that can accept multiple video and optional audio streams, even at full HD resolution (1920×1080), compress the streams, broadcast the data over a single high speed network that can be received by one or more receivers. By having a single transmitter accept multiple input sources and broadcast all sources over a single network, preferably a Gigabit network, this greatly reduces the cost of installations and maintenance.

The video/audio stream data may be sent across the network by breaking the compressed frames into a series of smaller packets and sending them across the network sequentially. It is the receiver's responsibility to “listen” for the desired video stream, and ignore packets from other streams. Packets from the desired video stream are then used to reconstruct the complete compressed frame for decompression and eventual output to the display device. There are a number of different methods that can be used so that a given receiver can filter out network packets that are associated with other video streams that it is not interested in displaying. At the highest level the transmitter may have multiple network connections and some streams may go out on one network interface, and other streams on other available network interfaces. Typically for broadcasting video, one of two network stream types are used: multicast and unicast.

If a video stream only needs to be received by one receiver, unicast is typically used since this is a point to point distribution method. For unicast the destination IP address is selected at the time the network connection is created and the packets are only received by that specific receiver. If a user wishes to change which receiver is to display a given unicast stream, the existing stream may be destroyed and a new one created for the new destination IP address. Unicast has the advantage though that it usually incurs less CPU load to send a given amount of data on the network.

If multiple receivers need to display the same video stream, multicast is used. Multicast streams have the advantage that once it is created, one or more receivers may “subscribe” to a multicast data stream at any time and begin to process its data packets for display, with no significant additional CPU load on the transmitter. No tear down and reconstruction of the stream is necessary for new receivers to begin receiving the stream.

Further features of the exemplary embodiments will be described or will become apparent in the course of the following detailed description.

### BRIEF DESCRIPTION OF THE DRAWINGS

A better understanding of the exemplary embodiments will be had when reference is made to the accompanying drawings, wherein identical parts are identified with identical reference numerals, and wherein:

FIG. 1 is a schematic showing a basic embodiment.

FIG. 2 is a schematic showing an example system setup.

### DETAILED DESCRIPTION OF A PREFERRED EMBODIMENT

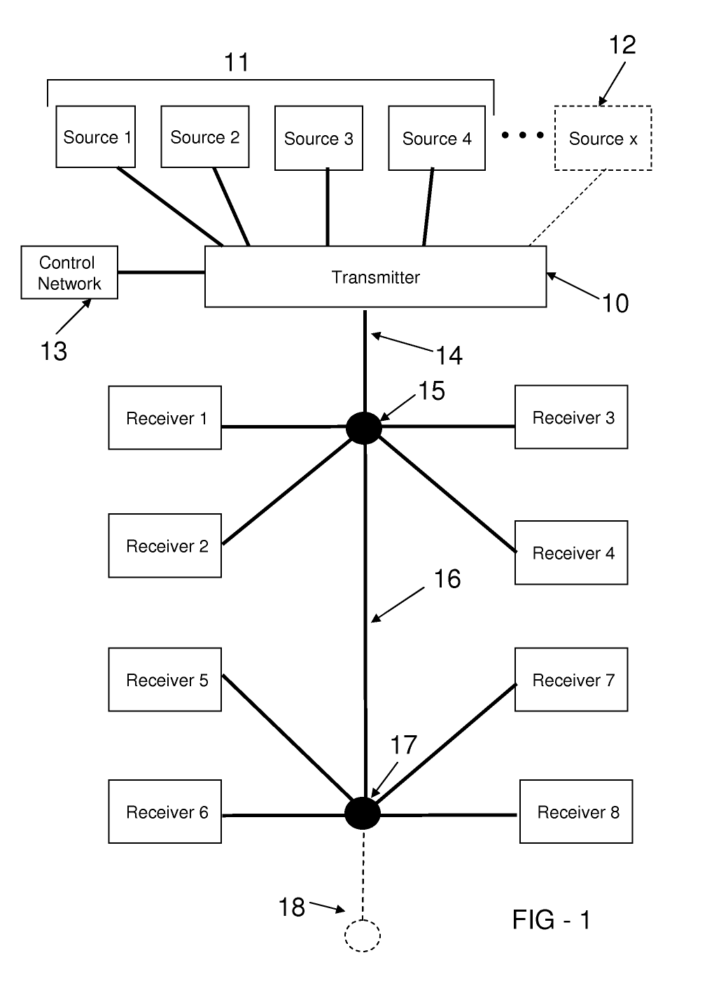

As shown in FIG. 1, a plurality of video sources 11 are in electrical communication with a transmitter 10. As mentioned above, the video sources 11 may be supplying video content at different resolutions and/or refresh rates. Optional audio content can also be supplied to the transmitter 10. An additional video source 12 is also shown to indicate that any number of video sources may be in communication with the transmitter 10. The number of video sources 11 and 12 is not fixed and the maximum number allowable is a function of how powerful the CPU processor is within the transmitter, the speed of the network, the resolution of the video sources, and the refresh requirement (eg. 2, 30, 60 or more frames per second).

The transmitter 10 can be thought of as a video server and can provide a variety of different functions. Through a controller board and processor, the transmitter 10 can accept a variety of different video sources and can properly convert, encode, compress, and multiplex the different video sources onto a single network cable 14. An exemplary cable would be a CAT5 or CAT6 cable. The transmitter 10 may also assemble the appropriate data packets and the associated headers for each packet which can be used as instructions for which receiver should be ‘listening’ to which video source as well as instructions for re-assembling the packets.

The transmitter 10 may have several physical output cables, or alternatively as shown in FIG. 1, a single cable 14 may exit the transmitter 10 but may later be combined with a network hub 15 which can then distribute the single cable 14 to multiple receivers (here Receivers 1-4) and associated displays. Although there are many advantages to this system, at least one advantage is that widely available network hubs can be used with different embodiments and these hubs are common to the industry and relatively inexpensive. In addition, the use of CAT5 or CAT6 cable is also much less expensive than other high definition video connections such as component, HDMI, DVI, or VGA. Further, CAT5 and CAT6 cables can span very long distances before signal degradation or signal loss becomes an issue. In other embodiments, rather than having a single cable exit the transmitter, the transmitter board would contain hardware which would support multiple PHY connections on the same network. Thus, multiple cables would exit the transmitter and run to the receivers. The precise setup of the transmitter and optional hubs would depend on the relative locations of the receivers and the transmitter.

Another cable 16 is shown leaving the hub 15 and connecting to a second hub 17 which may distribute the signal to several other receivers (here Receivers 5-8) and associated displays. Further, cables and hubs 18 can still be used to further distribute the signal. Each receiver may accept the video signal and based on information contained in the packet headers, can determine which video source the particular receiver is meant to ‘listen’ to.

The transmitter 10 may also have a connection to a control network 13 which permits a user to control the various attributes of the video sources, transmitter, and receivers. The control network 13 can also receive data from the electronic displays (not shown) which are connected to the receivers so that a user can monitor the displays and determine if they are performing properly or perhaps failed. In an exemplary embodiment, there is an http server which runs on the transmitter 10, and a user would communicate with this server through a web page interface on the control network 13. Web pages may be stored on the transmitter 10 and by using a web browser a user can perform many different functions (only limited by the functionality of the web pages stored on the transmitter and the software that they execute). For example, clicking on buttons or icons may in turn call up other web pages or run programs on the transmitter that can retrieve data from one or more receivers/displays. These commands and data retrieval could be sent over the same network that the video is being streamed on since these commands and data are relatively small in size when compared to the video streams. Alternatively, a separate network can be used to communicate data from the receivers/displays to the transmitter or from the receivers/displays directly to the user. This separate network could be wired or wireless.

In addition to the interactive web page interface, an Application Programming Interface (API) can be used where users can retrieve data from the transmitter and/or receivers/displays. This could be used for more specific purposes such as getting periodic status updates of all the units from a central control facility and detecting/logging failures.

Each video source 11 and 12 outputs a video stream (and sometimes audio stream) and has an associated IP address and port number. For example the first video source may be multicast on IP address 224.0.0.1 and port number 6200, the second video source may be multicast on the same IP address, but instead uses port number 6201. Any given receiver can then receive the desired video stream simply by “subscribing” to the appropriate multicast address and port number.

To do a complete system installation, obviously the transmitter and receivers have to be configured correctly to display the desired video streams. Using a web browser connected to one of the network interfaces on the transmitter and receivers (or alternatively a serial port), the desired configuration can be defined and stored on each unit (e.g. flash memory) so that the configuration may be maintained when the unit is turned off.

When a transmitter is installed, several things may need to be configured: the number of video sources connected, the resolution of each source, the output resolution to broadcast the image at the display (e.g. the video source may be scaled up or down), the rate at which to broadcast each source over the network in frames/second (e.g. if it is video the stream may be configured for 30 or even 60 frames per second, if it is cycling through static images it may be configured for 1 frame per second or even less), the compression attributes to be applied to each source (e.g. depending on the content a user may select different compression rates or algorithms, higher compression requires less network bandwidth, lower compression improves image quality), the method for network distribution (i.e. unicast or multicast), the network address and port number to use for the network stream, and the logical name associated with the video stream (e.g. Menu1, Menu2, TV Stream 1, Movie Trailers 1).

When a receiver is installed, the following things may need to be configured: resolution of the connected display device, the network address and port number to receive video from (or alternatively the stream name which has an implied network address associated with it), the minimum valid frame rate that can be received before marking the connection as failed, and an optional logo to be displayed in the event that no valid video stream is being received.

Once the transmitter 10 is configured, it can maintain a database of the connected video sources 11 and 12. The transmitter 10 is on the network at a known IP address and when an unconfigured receiver is attached to the network, it may inquire from the transmitter 10 the number of configured video sources and their attributes. Using an optional web page interface, the receivers can then be “bound” to a video stream, and the necessary software checks are enforced to make sure that a receiver is capable of receiving the specified stream (e.g. match of display resolution—Note that the transmitter and/or the receiver may scale the image to meet this requirement).

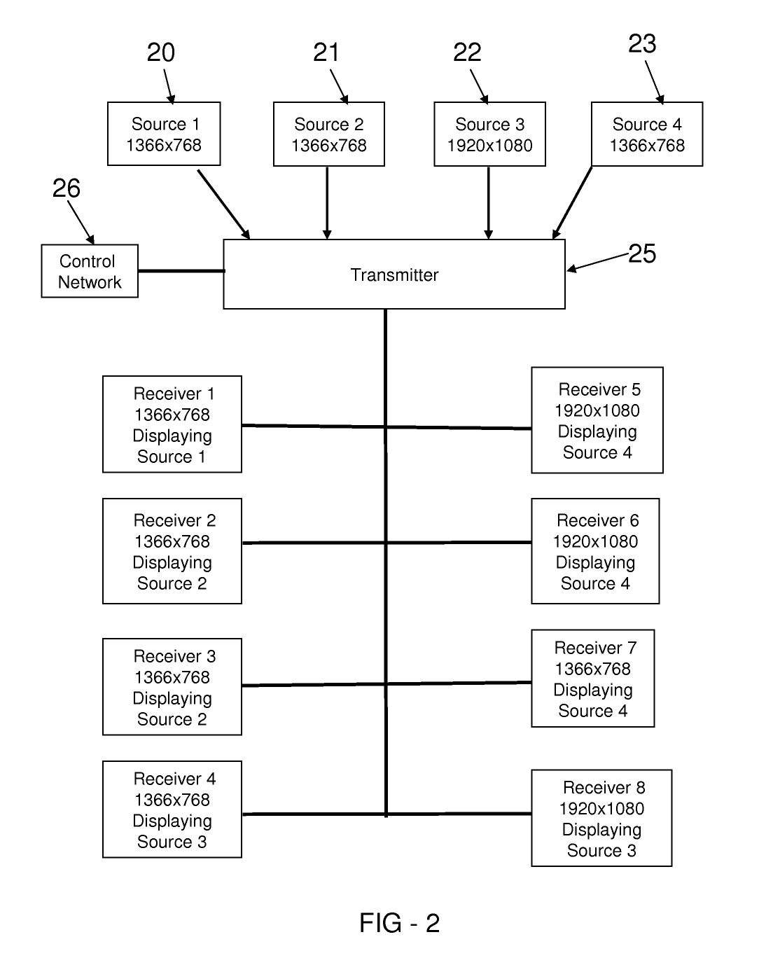

FIG. 2 shows a schematic view of an example for one possible installation. For this example there are four video sources 20, 21, 22, and 23 connected to transmitter 25. The four video sources are defined as:

Source 1 (20) 1366×768—unicast flow to Receiver 1, no scaling

Source 2 (21) 1366×768—multicast flow to Receivers 2 and 3, no scaling

Source 3 (22) 1920×1080—multicast flow to Receivers 4 and 8, Receiver 4 scales down to 1366×768 resolution

Source 4 (23) 1366×768—multicast flow to Receivers 5, 6 and 7, Receivers 5 and 6 scale stream up to 1920×1080 resolution

By using the control network 26, a user can change the settings for the system and direct different receivers to listen to or subscribe to a different video stream. Thus, a user can direct Receiver 2 to listen to Source 4 (23) rather than Source 2 (21) by calling up a web page and configuring the units. The new configuration would be sent to Receiver 2 over the video network and it may also be stored locally on the transmitter 25. Once this new configuration is stored, the software may restart or the unit may be rebooted automatically and when Receiver 2 comes up it would listen on the appropriate IP address and port in order to receive the video stream from Source 4 (23). This configuration would then continue until it may be changed sometime in the future. Data may be stored locally on the receivers also in a hard drive or flash drive manner.

The exemplary embodiments thus allow a user to maintain several different displays which may contain a combination of several different video sources. A simple and familiar web access can permit the user to monitor the system and make changes from any location with an internet connection. Cost, reliability, simplicity, and space are all reduced from previous multiple video source and display systems.

The electronic displays referred to herein could be any type of image-generating electronic display including but not limited to: LCD, OLED, light-emitting polymers, plasma, projection, DLP, OELD, and display types not yet discovered.

Having shown and described preferred embodiments, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. A system for distributing a plurality of unique video streams, the system comprising:
a plurality of video sources supplying a stream of video;
a transmitter in electrical communication with the video sources which accepts the video streams and attaches an identifier to each stream;
a plurality of receivers in electrical communication with the transmitter, each receiver is associated with an identifier and receives each video stream and selects only the stream with a matching identifier; and
an electronic display associated with each receiver which displays the selected video stream.

2. The system of claim 1 further comprising:
a control network in electrical communication with the transmitter.

3. The system of claim 2 further comprising:
a first network hub in electrical communication between the receivers and the transmitter.

4. The system of claim 1 wherein:
the transmitter compresses each video stream and multiplexes the compressed streams onto a single cable.

5. The system of claim 4 wherein:
the receivers demux and decompress the selected video stream prior to sending it to the electronic display.

6. The system of claim 1 wherein:
the electrical communications between the transmitter and receivers take place over a CAT5 cable.

7. The system of claim 1 wherein:
the electrical communications between the transmitter and receivers are two-way electrical communications.

8. The system of claim 3 further comprising:
a second network hub in electrical communication with the first network hub;
a plurality of receivers in electrical communication with the second network hub; and
an electronic display in electrical communication with each receiver.

9. The system of claim 2 further comprising:
an internet connection in electrical communication with the control network.

10. A system for distributing unique video streams, the system comprising:
a first video source supplying a first stream of video;
a second video source supplying a second stream of video;
a transmitter which accepts the video streams, compresses the video streams, attaches a first identifier to the first stream and a second identifier to the second stream, and multiplexes the two compressed streams onto a single cable;
a network hub in electrical communication with the single cable;
a first receiver connected to the network hub with a single cable, the first receiver is associated with the first identifier, demuxes the two compressed streams and decompresses the first stream of video;
a second receiver connected to the network hub with a single cable, the second receiver is associated with the second identifier, demuxes the two compressed streams and decompresses the second stream of video;
a first electronic display which receives the first stream of video from the first receiver; and
a second electronic display which receives the second stream of video from the second receiver.

11. The system of claim 10 further comprising:
a control network in electrical communication with the transmitter.

12. The system of claim 10 wherein:
the single cables are CAT5 cables.

13. The system of claim 10 wherein:
the single cables are CAT6 cables.

14. The system of claim 11 further comprising:
an internet connection in electrical communication with the control network.

15. The system of claim 10 further comprising:
a second network hub in electrical communication with the network hub.

16. A method for distributing unique video streams over a single cable, the method comprising the steps of:
presenting a plurality of unique video sources which supply a stream of video data;
dividing each stream of video data into a plurality of packets;
compressing the packets;
attaching a unique identifier with each packet that corresponds with the unique video source;
multiplexing the packets onto a single cable;
presenting a plurality of receivers, each receiver is associated with one of the unique identifiers;
distributing the packets to a plurality of receivers;
demuxing the packets;
accepting the packets if the identifier for the packet matches the identifier associated with the receiver;
decompressing the accepted packets; and
displaying the decompressed packets.

17. The method of claim 16 wherein:
the distributing step is performed by a network hub.

18. The method of claim 16 wherein:
the packets are multiplexed onto a single CAT5 cable.

19. The method of claim 16 further comprising the step of:
re-scaling a stream of video data prior to dividing it into packets.

20. The method of claim 16 wherein:
the displaying step is performed by liquid crystal displays.
